(19) United States
(12) Patent Application Publication
(10) Pub. No.: US 2024/0370730 A1
(43) Pub. Date: Nov. 7, 2024

(54) METHOD AND SYSTEM FOR OPTIMIZING PERFORMANCE OF GENETIC ALGORITHM IN SOLVING SCHEDULING PROBLEMS

(71) Applicant: Quantiphi, Inc., Marlborough, MA (US)

(72) Inventors: Dagnachew Birru, Marlborough, MA (US); Achint Chaudhary, Mumbai (IN); Anirudh Deodhar, Mumbai (IN)

(73) Assignee: Quantiphi, Inc, Marlborough, MA (US)

(21) Appl. No.: 18/766,733

(22) Filed: Jul. 9, 2024

(51) Int. Cl. G06N 3/086; G06Q 10/0631

(52) U.S. Cl. CPC G06N 3/086; G06Q 10/0631

(57) ABSTRACT

A method and system for optimizing performance of Genetic Algorithm (GA) in solving scheduling problem is disclosed. The method includes receiving input constraints associated with supply and demand sides, for scheduling problem. The method include initializing set of schedules using initializer that sets initial set of solutions for GA to start optimization. The method may include generating parent population for GA. The method may include creating child population via evolution using current probabilistic parameters including crossover and mutation operators. The method may include utilizing a Multi-Level Hierarchical Grouping (MLHG) to de-duplicate child population. The method includes determining a new population from a total population including the parent population and the child population, using custom multi-objective sorting technique. The method may further include updating probabilistic parameters of the GA during runtime using runtime adapter, when pre-determined iterations unattained. The probabilistic parameters are updated iteratively until an optimized schedule is attained.

### FIELD OF THE INVENTION

The present disclosure relates to workforce optimization, and more specifically to a method and system for optimizing performance of genetic algorithm in solving scheduling problems.

### BACKGROUND OF THE INVENTION

The Work-force optimization is a widely applicable area with the domain of Operations Research (OR) which finds its applications in all industries ranging from Healthcare, Manufacturing, Retails, and many others. Nurse Rostering Problem (NRP) is the oldest and most widely studied type of work-force optimization that can be generalized beyond hospitals. Yet it serves as a critical starting point in the modern economy where shortage in healthcare staff and poor job-satisfaction is often reported by lead organizations.

With high quality rosters built in advance, hospitals can maximize productivity of their workforce, increase operational efficiency, ensure fair workload distribution and higher job satisfaction among nurses.

Due to the vast search space of possible rosters, AI based classical search techniques limit their applicability in even the smallest of practical usage. With at least three decades of work in the field of nurse rostering, one can start to work with multiple potential techniques that have been the foundation of multiple works. In particular Linear Programming (LP) or Mixed-Integer Linear Programming (MILP) is most popularly used in most published works. This is followed by Genetic Algorithm or other similar Evolutionary Algorithms (EAs) like Artificial Bee Colony (ABC). Recently there is a limited but also an emergent trend of using Neural Network in the field. But applications with Machine Learning and Neural Networks require vast amounts of data to train and are not yet proven to be robust in extrapolation setup which limits their practical usage at the same time.

Despite multiple works in the area around exploration of promising solutions, the field still lacks standardized and challenging open-source datasets on which the same set of solvers can be empirically evaluated.

Despite advances made in Genetic Algorithms, the solvers remain computationally expensive and time consuming, limiting their applicability in dynamic and real-time scheduling.

Therefore, there is a need for a method and system for optimizing performance of genetic algorithm in solving scheduling problems to overcome above mentioned technical problems.

### SUMMARY

The following embodiments presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide a computer-implemented method for optimizing performance of a Genetic Algorithm (GA) in solving a scheduling problem, the method may include receiving inputs constraints associated with supply and demand sides, for the scheduling problem. The method may further include initializing a set of schedules using an initializer that sets an initial set of solutions for the GA to start the optimization. The method may further include generating a parent population for the GA. The parent population includes a collection of potential solutions to the scheduling problem. The method may further include creating a child population via evolution using current probabilistic parameters including crossover and mutation operators. New candidate solutions are produced by combining or modifying solutions of the collection of potential solutions from the parent population. The method may further include utilizing a Multi-Level Hierarchical Grouping (MLHG) to de-duplicate the child population. The new candidate solutions are organized into hierarchical groups, and duplicates from the new candidates are removed. The method may further include determining a new population from a total population including the parent population and the child population, using a custom multi-objective sorting technique. The new population comprises top-performing solutions. The method may further include updating probabilistic parameters of the GA during runtime using a runtime adapter, when pre-determined iterations unattained. The probabilistic parameters are updated iteratively until an optimized schedule is attained.

According to some example embodiments, the method further includes determining if the pre-determined iterations are attained to determine whether the optimization has achieved pre-defined results or further iterations are required. The determination is one of a successful determination or an unsuccessful determination.

According to some example embodiments, the method further includes at least one of upon the successful determination, rendering final schedules with optimal statistics and trade-offs as output or upon the unsuccessful determination, updating the probabilistic parameters of the GA during runtime using the runtime adapter.

According to some example embodiments, wherein the initializer is a Monte Carlo Tree Search (MCTS) initializer.

According to some example embodiments, wherein the custom multi-objective sorting technique is used to combine the parent population and the child population, sort the combination based on multiple optimization objectives, and select the top-performing solutions for a next generation.

According to some example embodiments, the method further includes classifying the new population into groups based on whether a crossover or a mutation is performed, facilitating dynamic adaptation of GA parameters to different operators.

According to some example embodiments, wherein summary statistics are computed for each group of the groups, and wherein computation of the summary statistics provides insight into performance of different subsets of solutions, and guides adjustments for the probabilistic parameters.

According to some example embodiments, wherein the summary statistics includes a mean objective value.

According to some example embodiments, wherein adjustments to be made in each probabilistic parameter are calculated based on the summary statistics obtained in a previous step, allowing for informed adjustments to GA's behavior.

According to some example embodiments, wherein the probabilistic parameters are adjusted based on contribution of hyper-parameters in previous iterations to improve convergence and solution quality, leveraging past performance to inform future parameter adjustments.

Some example embodiments disclosed herein provide a computer-implemented system for optimizing performance of a Genetic Algorithm (GA) in solving a scheduling problem. The computer-implemented system includes a memory, and a processor communicatively coupled the memory, configured to receive inputs constraints associated with supply and demand sides, for the scheduling problem. The processor further configured to initialize a set of schedules using an initializer that sets an initial set of solutions for the GA to start the optimization. The processor further configured to generate a parent population for the GA. The parent population includes a collection of potential solutions to the scheduling problem. The processor further configured to create a child population via evolution using current probabilistic parameters comprising crossover and mutation operators. New candidate solutions are produced by combining or modifying solutions of the collection of potential solutions from the parent population. The processor further configured to utilize a Multi-Level Hierarchical Grouping (MLHG) to de-duplicate the child population. The new candidate solutions are organized into hierarchical groups, and duplicates from the new candidates are removed. The processor further configured to determine a new population from a total population comprising the parent population and the child population, using a custom multi-objective sorting technique. The new population comprises top-performing solutions. The processor further configured to updating probabilistic parameters of the GA during runtime using a runtime adapter, when pre-determined iterations unattained. The probabilistic parameters are updated iteratively until an optimized schedule is attained.

Some example embodiments disclosed herein provide a non-transitory computer readable medium having stored thereon computer executable instruction which when executed by one or more processors, cause the one or more processors to carry out operations for optimizing performance of a Genetic Algorithm (GA) in solving a scheduling problem, the operations comprising receiving inputs constraints associated with supply and demand sides, for the scheduling problem. The operations further comprising initializing a set of schedules using an initializer that sets an initial set of solutions for the GA to start the optimization. The operations further comprising generating a parent population for the GA. The parent population comprises a collection of potential solutions to the scheduling problem. The operations further comprising creating a child population via evolution using current probabilistic parameters comprising crossover and mutation operators. New candidate solutions are produced by combining or modifying solutions of the collection of potential solutions from the parent population. The operations further comprising utilizing a Multi-Level Hierarchical Grouping (MLHG) to de-duplicate the child population. The new candidate solutions are organized into hierarchical groups, and duplicates from the new candidates are removed. The operations further comprising determining a new population from a total population comprising the parent population and the child population, using a custom multi-objective sorting technique. The new population comprises top-performing solutions. The operations further comprising updating probabilistic parameters of the GA during runtime using a runtime adapter, when pre-determined iterations unattained. The probabilistic parameters are updated iteratively until an optimized schedule is attained.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 is a block diagram of an environment of a system for optimizing performance of genetic algorithm in solving scheduling problems, in accordance with an example embodiment.

FIG. 2 is a block diagram illustrating various modules within a memory of a computing device configured for optimizing performance of a Genetic Algorithm (GA) in solving a scheduling problem, in accordance with an example embodiment.

FIG. 3 illustrates a flow diagram of a method for optimizing performance of the GA in solving a scheduling problem, in accordance with an example embodiment.

FIG. 4 illustrates a flow diagram of a method for determining if the pre-determined iterations are attained, in accordance with an example embodiment

FIG. 5 illustrates a flow diagram of a method for optimizing performance of the GA in solving a scheduling problem, in accordance with an example embodiment

FIG. 6 illustrates a flow diagram of a method for de-duplicating child population, in accordance with an example embodiment.

FIG. 7 illustrates an exemplary flow diagram of a method for runtime adaption of GA parameters, in accordance with an example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “Genetic Algorithm (GA)” may reflect the process of natural selection where the fittest individuals are selected for reproduction in order to produce the offspring of the next generation. The process of natural selection starts with the selection of fittest individuals from a population. They produce offspring which inherit the characteristics of the parents and will be added to the next generation. If parents have better fitness, their offspring will be better than the parents and have a better chance at surviving. This process keeps on iterating and at the end, a generation with the fittest individuals will be found.

The term “machine learning model” may be used to refer to a computational or statistical or mathematical model that is trained on classical ML modelling techniques with or without classical image processing. The “machine learning model” is trained over a set of data and using an algorithm that it may be used to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The term “Multi-Level Hierarchical Grouping (MLHG)” may be a method used to organize data or elements into nested layers of categories or groups. Each level of the hierarchy represents a different granularity or scope of classification, enabling complex structures to be broken down into simpler, more manageable substructures. This method is particularly useful in various fields such as data analysis, machine learning, database management, and organizational structures, where it aids in efficient data retrieval, management, and understanding.

The term “Probabilistic parameters” may represent variables within a predictive model that are characterized by uncertainty and variability. Unlike deterministic parameters, which have fixed values, probabilistic parameters are described by probability distributions, reflecting the inherent uncertainty and variability in their values. These parameters are used to account for the stochastic nature of real-world processes and are critical in enhancing the robustness and reliability of the predictive model.

The term “Monte Carlo Tree Search (MCTS)” may be a heuristic search algorithm used for decision-making processes, particularly in artificial intelligence applications such as game playing, robotics, and other complex scenarios.

### End of Definitions

As described earlier, traditional methods of optimizing scheduling problems rely heavily on human expertise and conventional numerical methods, which are time-consuming and often suboptimal. The present disclosure addresses these challenges by introducing a method and system for optimizing performance of a Genetic Algorithm (GA) in solving a scheduling problem. The proposed method and system use Genetic algorithm, a Multi-Level Hierarchical Grouping (MLHG) to de-duplicate the child population. Further, the proposed method and system iteratively update probabilistic parameters of the GA during runtime using a runtime adapter to optimize the scheduling problem.

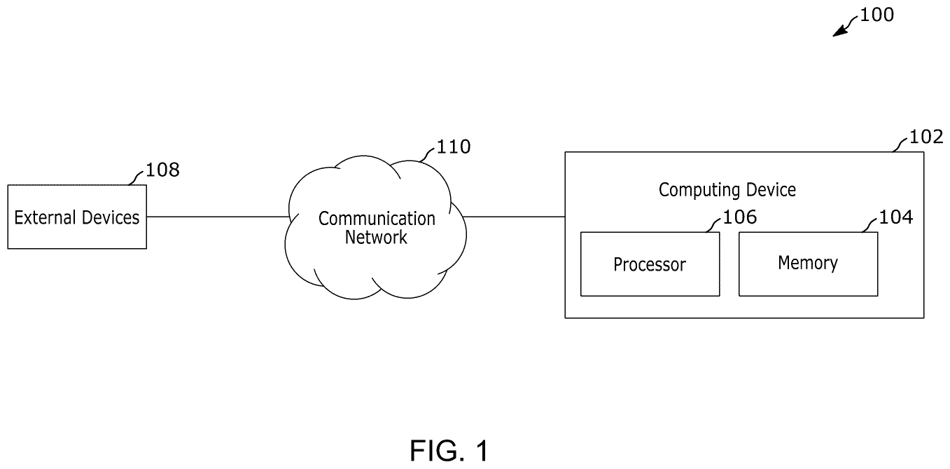

Embodiments of the present disclosure may provide a method, a system, and a computer program product for optimizing performance of a Genetic Algorithm (GA) in solving a scheduling problem. The method, the system, and the computer program product update the GA for optimizing scheduling problem in such an improved manner are described with reference to FIG. 1 to FIG. 7 as detailed below.

FIG. 1 illustrates a block diagram of an environment of a system 100 for optimizing performance of the GA in solving a scheduling problem, in accordance with an example embodiment. The system 100 is designed to facilitate efficient and accurate optimization of the scheduling problems, such as nurse staffing schedule, corporate employee scheduling roster by utilizing advanced computational techniques and automated experiment design. The system 100 is implemented in a nurse staffing problem for the sake of simplicity. The system 100 includes a computing device 102 and external devices 108. The computing device 102 may be communicatively coupled with the external devices 108 via a communication network 110. Examples of the computing device 102 may include, but are not limited to, a server, a desktop, a laptop, a notebook, a tablet, a smartphone, a mobile phone, an application server, or the like.

The communication network 110 may be wired, wireless, or any combination of wired and wireless communication networks, such as cellular, Wi-Fi, internet, local area networks, or the like. In one embodiment, the network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The computing device 102 may include a memory 104, and a processor 106. The term “memory” used herein may refer to any computer-readable storage medium, for example, volatile memory, random access memory (RAM), non-volatile memory, read only memory (ROM), or flash memory. The memory 104 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 106 may retrieve computer program code instructions that may be stored in the memory 104 for execution of the computer program code instructions. The processor 106 may be embodied in a number of different ways. For example, the processor 106 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 106 may include one or more processing cores configured to perform independently. A multi-core processor may enable multiprocessing within a single physical package. Additionally, or alternatively, the processor 106 may include one or more processors configured in tandem via the bus to enable independent execution of instructions, pipelining, and/or multithreading.

Additionally, or alternatively, the processor 106 may include one or more processors capable of processing large volumes of workloads and operations to provide support for big data analysis. In an example embodiment, the processor 106 may be in communication with a memory 104 via a bus for passing information among components of the system 100.

The memory 104 may be non-transitory and may include, for example, one or more volatile and/or non-volatile memories. In other words, for example, the memory 104 may be an electronic storage device (for example, a computer readable storage medium) comprising gates configured to store data (for example, bits) that may be retrievable by a machine (for example, a computing device like the processor 106). The memory 104 may be configured to store information, data, contents, applications, instructions, or the like, for enabling the apparatus to carry out various functions in accordance with an example embodiment of the present disclosure. For example, the memory 104 may be configured to buffer input data for processing by the processor 106.

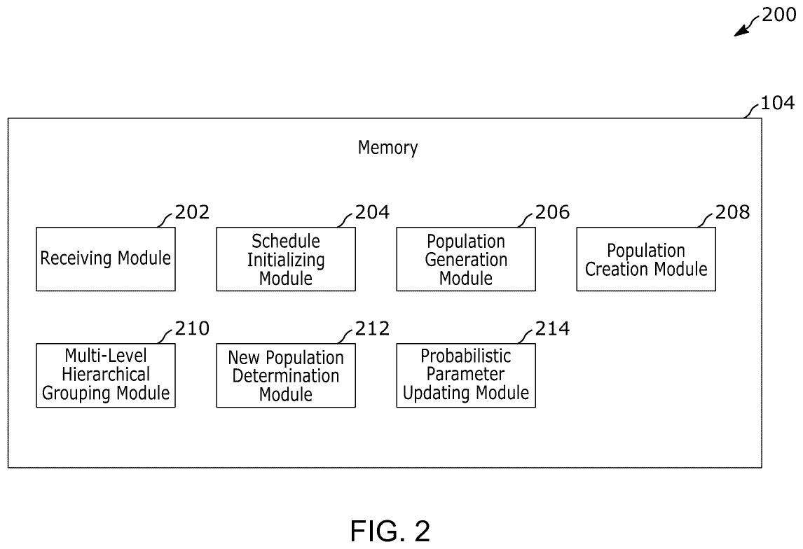

The computing device 102 may be capable of optimizing performance of the GA in solving a scheduling problem. The memory 104 may store instructions that, when executed by the processor 106, cause the computing device 102 to perform one or more operations of the present disclosure which will be described in greater detail in conjunction with FIG. 2. The computing device 102 is responsible for performing tasks such as receiving input constraints associated with supply and demand sides, initializing a set of schedules using an initializer, generating a parent population for the GA, and utilizing a Multi-Level Hierarchical Grouping (MLHG) to de-duplicate the child population. The computing device 102 continually learns and updates the GA in real-time based on incoming data from the iterations, ensuring that the optimization component iteratively improves the optimization of the scheduling problem.

The external devices 108 may refers to various hardware and software tools that may be integrated with the system 100 to enhance its functionality. These devices may include sensors, actuators, and other measurement instruments that provide real-time data from the optimization process. The complete process followed by the system 100 is explained in detail in conjunction with FIG. 2 to FIG. 7.

FIG. 2 illustrates a block diagram 200 illustrating various modules within the memory 104 of the computing device 102 configured for optimizing performance of the GA in solving a scheduling problem, in accordance with an example embodiment. The memory 104 may include a receiving module 202, a schedule initializing module 204, a population generation module 206, a population creation module 208, a multi-level hierarchical grouping module 210, a new population determination module 212, and a probabilistic parameter updating module 214.

The receiving module 202 is responsible for receiving inputs constraints associated with supply and demand sides, for the scheduling problem. The input constraints for a Nurse Staffing Problem (NRP) may include three main scalers: i) Number of employees (N), Emps ii) Number of shifts per day (N), and iii) Time-horizon, such as number of days to create Shift N days. An assignment of an employee (e) to any particular day (d) and shift(s) may be represented by indicator variable(S). Indicator variables for all employees, days, and shifts e, d, s may be encoded in a three-dimensional Boolean tensor of shape N_{Emps}*N_{Days}*N_{Shifts}.

Further, the system 102 may require a hard constraints and soft constraints. The hard constraints are the constraints that must be followed to optimize the NRP. The hard constraints may include single-shift constraint, shift rotation constraint, maximum number of shifts, maximum total minutes, maximum consecutive assignments, minimum consecutive assignments, minimum consecutive days-off, maximum number of weekends, day-off, minimum-cover constraint, and alike. Further, the single-shift constraint may mean employees cannot be assigned more than one shift on a day. The shift rotation constraint may mean shifts which may not follow the shift on the previous day. this constraint always assumes that the last day of the previous planning period was a day off and the first day of the next planning horizon is a day off. The maximum number of shifts may mean shifts of each type that may be assigned to each employee. The maximum total minutes may mean maximum amount of total time in minutes that can be assigned to each employee. The duration in minutes of each shift is defined.

The maximum consecutive assignments may mean maximum number of consecutive shifts that can be worked before having a day off. This constraint always assumes that the last day of the previous planning period was a day off and the first day of the next planning period is a day off. The minimum consecutive assignments may mean minimum number of shifts that must be worked before having a day off. This constraint always assumes that there are an infinite number of consecutive shifts assigned at the end of the previous planning period and at the start of the next planning period. The maximum number of weekends may mean minimum number of consecutive days off that must be assigned before assigning a shift. This constraint always assumes that there are an infinite number of consecutive days off assigned at the end of the previous planning period and at the start of the next planning period. The minimum-cover constraint may mean shifts must not be assigned to the specified employee on the specified days.

Further, the soft constraints may include shift-off requests, shift-on requests, under-cover constraint, over-cover constraint. the shift-off requests may mean that the specified shift is assigned to the specified employee on the specified day then the solution's penalty is the weight value. The shift-on requests may mean that the specified shift is not assigned to the specified employee on the specified day then the solution's penalty is the specified weight value. The under-cover constraint may mean that the required number of staff on the specified day for the specified shift is not assigned then it is a soft constraint violation.

The schedule initializing module 204 is configured to initializing a set of schedules using an initializer that sets an initial set of solutions for the GA to start the optimization. The schedule initializing module 204 may initialize a schedule based on the received hard constraints. The initialization is done in a way that the hard constraints are satisfied from beginning to the end of the optimization process. Schedules are initialized in a way that all hard-constraints are always satisfied and the search space where any hard-constraint may get violated is pruned to prevent exponentially large compute expenditure for obtaining feasible schedules. Also, evolutionary operators (crossover and mutation) are applied only in such a way that the evolutionary operators too do not result in any hard-constraint violation, and the evolutionary operators that can cause hard-constraint violated are pruned out of possibilities.

The population generation module 206 is configured to generate a parent population for the GA. The parent population includes a collection of potential solutions to the scheduling problem. A pool of solutions is iterated to optimize the scheduling problem, called as parent population, and since GA may be terminated after any number of generations (even zero) this requires all of the solutions to satisfy all hard constraints of NRP instance. The loop-invariant of satisfying all hard constraints requires generating candidate schedules which can generate initial schedules that satisfy all hard constraints and later optimize them with respect to Objective values or soft constraints violations.

The population creation module 208 is configured to create a child population via evolution using current probabilistic parameters including crossover and mutation operators. New candidate solutions are produced by combining or modifying solutions of the collection of potential solutions from the parent population. The genetic algorithm iteratively optimizes the pool of feasible schedules which are fed by schedule initializing module 204. Iterative workflow of a genetic algorithm involves an evolution phase followed by a re-ranking and slicing phase. While each of these phases can itself have multiple procedures, the role of the evolution phase is to generate new schedules by combining schedules from the existing pool of parent population to create a new set of schedules known as child population.

The multi-level hierarchical grouping module 210 is configured to de-duplicate the child population. The new candidate solutions are organized into hierarchical groups, and duplicates from the new candidates are removed. Further, re-ranking and slicing phase arranges all available schedules from parent and child population, combines and arranges them in the decreasing order of their fitness (in terms of objective value) and takes only the top N schedules to be used as parent population for next iteration. Role of evolution phase is to generate new schedules to be appended to the child population by exploiting existing rosters in the parent population. This involves operators like i) Parent selection, ii) Cross-over, iii) Mutation. The multi-level hierarchical grouping is utilized for performing evolutionary steps on these two parents and this results into production of two new candidate schedules. These two newly produced candidate rosters are first checked for de-duplication in the existing parent and child population. If it turns out that they are indeed unique, they are appended to the child population, else the evolutionary process repeats.

The new population determination module 212 is configured to determine a new population from a total population including the parent population and the child population, using a custom multi-objective sorting technique. The new population includes top-performing solutions. The custom multi-objective sorting technique is used to combine the parent population and the child population, sort the combination based on multiple optimization objectives; and select the top-performing solutions for a next generation.

The probabilistic parameter updating module 214 is configured to update probabilistic parameters of the GA during runtime using a runtime adapter, when pre-determined iterations are unattained. The probabilistic parameters are updated iteratively until an optimized schedule is attained. The evolutionary operators Crossover, Mutation are known to carry out blind evolutionary updates, and selecting a good operation over a bad is left to the re-ranking (sorting) phase of the genetic algorithm. However, highly vectorized implementations are able to compute the gains or losses in terms of objective value before actually performing any actual crossover or mutation. Then based on the quantified gain (or loss) in terms of objective values, the crossover points, or mutation points are sampled in a probabilistic way such that the crossover and mutation that have higher impact on generated new schedule is preferred more over the other possibilities. The hyperparameters include crossover probability and mutation probability denoting in what fraction of child population schedule generation should use crossover and mutation, respectively. But, selecting values of these hyperparameters that result in optimal performance of GA solver may be tricky, and is subject to hyperparameter optimization like methods involved in Machine Learning literature like Grid-search, Random-search, or Bayesian-search within hyperparameter space.

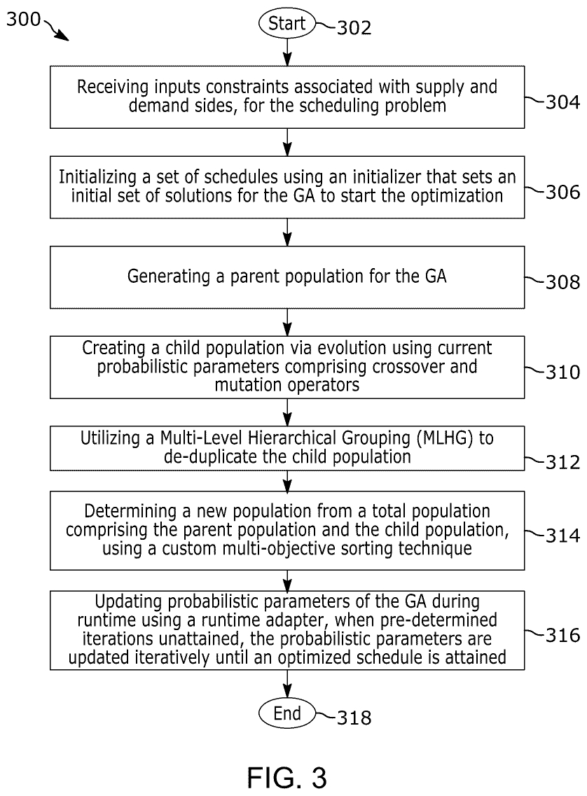

FIG. 3 illustrates a flow diagram of a method 300 for optimizing performance of the GA in solving a scheduling problem, in accordance with an example embodiment. It will be understood that each block of the flow diagram of the method 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 300 illustrated by the flow diagram of FIG. 3 for optimizing performance of a Genetic Algorithm (GA) in solving a scheduling problem may start at step 302. Further, the method 300 may include receiving inputs constraints associated with supply and demand sides, for the scheduling problem, at step 304. The input constraints may include hard constraints and soft constraints. The hard constraints are the constraints that must be followed to optimize the NRP. The hard constraints may include single-shift constraint, shift rotation constraint, maximum number of shifts, maximum total minutes, maximum consecutive assignments, minimum consecutive assignments, minimum consecutive days-off, maximum number of weekends, day-off, minimum-cover constraint, and alike. Further, the soft constraints may include shift-off requests, shift-on requests, under-cover constraint, and over-cover constraint.

The method 300, at step 306, may include initializing a set of schedules using an initializer that sets an initial set of solutions for the GA to start the optimization. This approach utilizes hard constraints to initialize a set of schedules to optimize the solution. The initializer is a Monte Carlo Tree Search (MCTS) initializer. The MCTS are used to generate feasible schedule, i.e., set of schedules that satisfy all hard constraints. While obtaining such feasible schedule via random rollouts may be exponentially difficult, a mechanism is placed in place that upon each increment in time-horizon (populating roster from day i to i+1). A sample of employees among multiple possibilities is obtained such that this sample respects all point, junction, and cumulative constraints. If there is no such possible sample, the monte-carlo rollout is re-started from the beginning without any complex backtracking.

At step 308, the method 300 may include, generating a parent population for the GA. The parent population includes a collection of potential solutions to the scheduling problem. The parent population includes a collection of potential solutions to the scheduling problem. A pool of solutions is iterated to optimize the scheduling problem called parent population, and since GA may be terminated after any number of generations (even zero) this requires all of the solutions to satisfy all hard constraints of NRP instance. The loop-invariant of satisfying all hard constraints requires generating candidate schedules which can generate initial schedules that satisfy all hard constraints and later optimize them with respect to objective values or soft constraints violations.

At step 310, the method 300 may include, creating a child population via evolution using current probabilistic parameters including crossover and mutation operators. New candidate solutions are produced by combining or modifying solutions of the collection of potential solutions from the parent population. The genetic algorithm iteratively optimizes the pool of feasible schedules which are fed by schedule initializing module 204. Iterative workflow of a genetic algorithm involves an evolution phase followed by a re-ranking and slicing phase. While each of these phases can itself have multiple procedures, the role of the evolution phase is to generate new schedules by combining schedules from the existing pool of parent population to create a new set of schedules known as child population.

At step 312, the method 300 may include, utilizing a Multi-Level Hierarchical Grouping (MLHG) to de-duplicate the child population. The new candidate solutions are organized into hierarchical groups, and duplicates from the new candidates are removed. Multi-level hierarchical grouping, is a custom statistical method that analyses data with hierarchical structures. It considers how observations are grouped at different levels, and accounts for both within-group and between-group variations. This can provide insights into how individual-level factors interact with group-level influences. The MLHG is utilized for performing evolutionary steps on these two parents and this results into production of two new candidate schedules. These two newly produced candidate rosters are first checked for de-duplication in the existing parent and child population. If it turns out that they are indeed unique, they are appended to the child population, else the evolutionary process repeats.

At step 314, the method 300 may include, determining a new population from a total population comprising the parent population and the child population, using a custom multi-objective sorting technique. The new population includes top-performing solutions. The custom multi-objective sorting technique is used to combine the parent population and the child population, sort the combination based on multiple optimization objectives, and select the top-performing solutions for a next generation. Role of the genetic algorithm is to iteratively optimize the pool of feasible schedules which are fed by schedule initialization module 204. Iterative workflow of a genetic algorithm involves an evolution phase followed by a re-ranking and slicing phase. While each of these phases may itself have multiple procedures, the role of the evolution phase is to generate new rosters by combining rosters from the existing pool of parent population to create a new set of rosters known as child population. And re-ranking and slicing phase arranges all available schedules from parent and child population, combines and arranges them in the decreasing order of their fitness (in terms of objective value) and takes only the top N rosters to be used as parent population for next iteration.

At step 316, the method 300 may include updating probabilistic parameters of the GA during runtime using a runtime adapter, when pre-determined iterations are unattained. The probabilistic parameters are updated iteratively until an optimized schedule is attained. Selecting values of these hyperparameters that result in optimal performance of GA solver may be tricky and is subject to hyperparameter optimization like methods involved in Machine Learning literature like Grid-search, Random-search, or Bayesian-search within hyperparameter space. The method 300 ends at step 418.

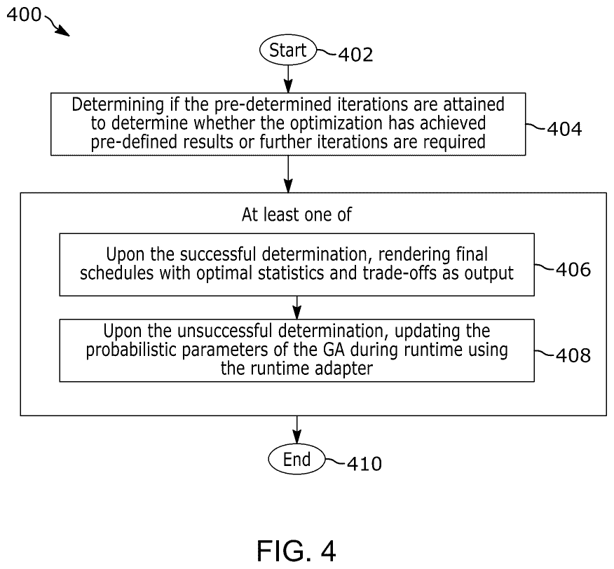

FIG. 4 illustrates a flow diagram of a method 400 for determining if the pre-determined iterations are attained, in accordance with an example embodiment. It will be understood that each block of the flow diagram of the method 400 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 4 is explained in conjunction with elements from FIGS. 1, 2, and 3. At step 402, the method 400 is initiated. The method 400, at step 404 may include determining if the pre-determined iterations are attained to determine whether the optimization has achieved pre-defined results or further iterations are required. The determination is one of a successful determination or an unsuccessful determination. For the first few iterations the crossover probability is increased, while in the latter half of iterative optimization mutation probability is increased to allow for better exploration.

Further, the method 400, at step 406, may include rendering final schedules with optimal statistics and trade-offs as output, upon the successful determination. Further, the method 400, at step 408, may include updating the probabilistic parameters of the GA during runtime using the runtime adapter, upon the unsuccessful determination. The method 400 ends at step 410.

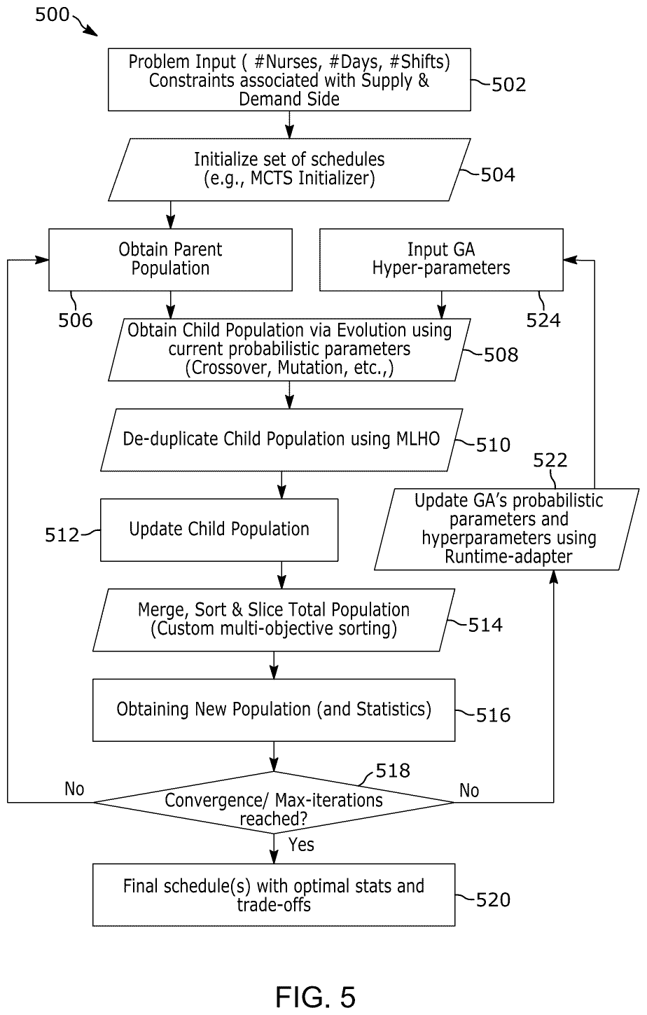

FIG. 5 illustrates an exemplary flow diagram of a method 500 for optimizing performance of the GA in solving a scheduling problem, in accordance with an example embodiment. FIG. 5 is explained in conjunction with elements from FIGS. 1, 2, 3, and 4. At step 502, the method 500 may include receiving inputs constraints associated with supply and demand sides, for the scheduling problem. Upon receiving the input, the method 500, at step 504 may further include initializing a set of schedules using an initializer that sets an initial set of solutions for the GA to start the optimization. The initializer is a Monte Carlo Tree Search (MCTS) initializer.

Further, the method 500, at step 506 may further include generating a parent population for the GA. The parent population comprises a collection of potential solutions to the scheduling problem. Further, the method 500, at step 508 may further include obtaining a child population via evolution using current probabilistic parameters including crossover and mutation operators. New candidate solutions are produced by combining or modifying solutions of the collection of potential solutions from the parent population.

Further, the method 500, at step 510, include utilizing a Multi-Level Hierarchical Grouping (MLHG) to de-duplicate the child population. The new candidate solutions are organized into hierarchical groups, and duplicates from the new candidates are removed. Further, at step 512, the child population are updated based on the iteration of the genetic algorithm. The method 500, at step 514, the method includes multi-objective sorting of the total population using merging, sorting, and slicing operations.

The method 500, at step 516, include obtaining a new population from a total population comprising the parent population and the child population, using a custom multi-objective sorting technique. The new population includes top-performing solutions. At step 518, the method includes determining if the pre-determined iterations are attained to determine whether the optimization has achieved pre-defined results or further iterations are required which transfers control to step 506. The determination is one of a successful determination or an unsuccessful determination.

Further, upon successful determination at step 518, the method, at step 520, includes rendering final schedules with optimal statistics and trade-offs as output to the external device 108. Further, upon unsuccessful determination at step 518, the method, at step 522 includes updating the GA probabilistic parameters using runtime adapter. Finally, upon updating probabilistic parameters at step 522, the method 500, at step 524 includes inputting the GA parameters to create child population at step 508.

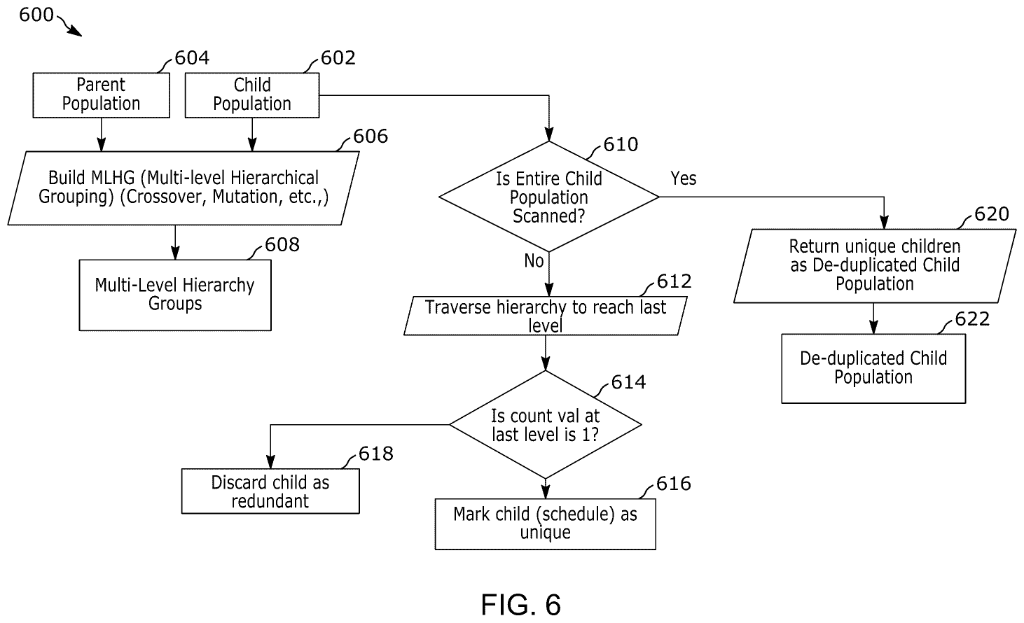

FIG. 6 illustrates a flow diagram of a method 600 for de-duplicating child population, in accordance with an example embodiment. FIG. 6 is explained in conjunction with elements from FIGS. 1, 2, 3, 4, and 5. The method 600, at steps 602 and 604 may include creating parent population and child population corresponding to the schedules and the input constraints. The method 600, at step 606, include utilizing a Multi-Level Hierarchical Grouping (MLHG) to de-duplicate the child population. Further, the method 600, at step 608 includes classifying the new population into groups based on whether a crossover or a mutation is performed, facilitating dynamic adaptation of GA parameters to different operators. The new candidate solutions are organized into hierarchical groups, and duplicates from the new candidates are removed.

Further, the method 600, at step 610, may include determining if the child population is scanned for the optimized schedule. If the child population is not scanned at step 610, the method 600, at step 612, further include traversing hierarchy of the MLHG group to reach last child population. Further, the method 600, at step 614 include determining if the populated child is unique or redundant. Further, the method 600, at step 616, include marking the child population as unique. The method 600, at step 618, include marking the child population as redundant.

The method 600, at step 620, include returning unique child population as de-duplicated child population. Finally, the method 600, at step 622 includes updating the de-duplicated child population in the GA.

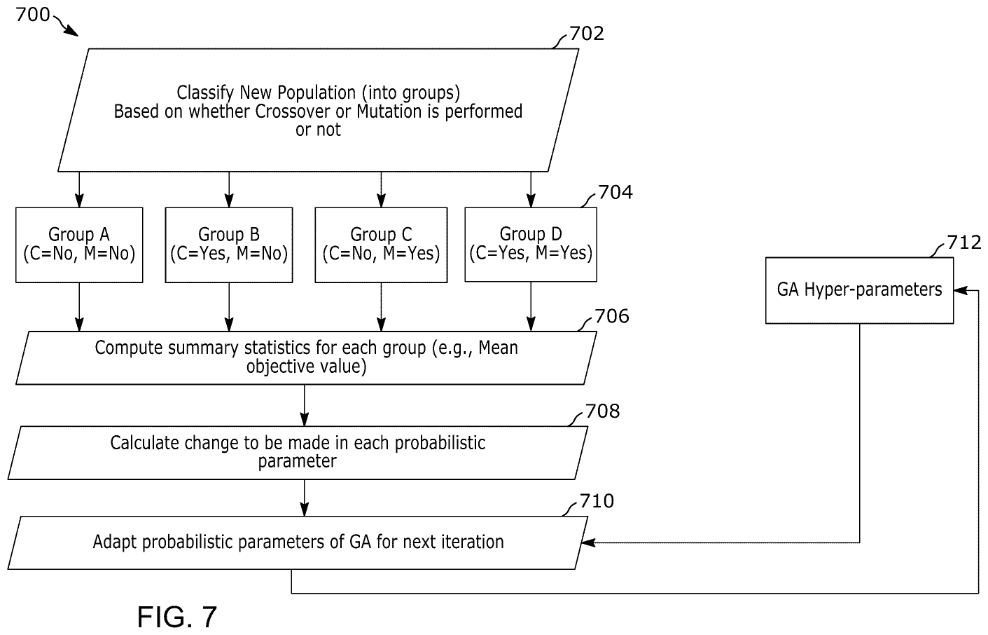

FIG. 7 illustrates a flow diagram of a method 700 for runtime adaption of GA parameters, in accordance with an example embodiment. FIG. 7 is explained in conjunction with elements from FIGS. 1, 2, 3, 4, 5, and 6. The method 700, at step 702 may include classifying the new population into groups based on whether a crossover or a mutation is performed, facilitating dynamic adaptation of GA parameters to different operators. The method 700, at step 704 may include creating a plurality of groups based on the crossover and mutation, such as Group A, Group B, Group C, and Group D.

Further, the method 700, at step 706, may include computing summary statistics for each group of the groups. The computation of the summary statistics provides insight into performance of different subsets of solutions, and guides adjustments for the probabilistic parameters. The summary statistics includes a mean objective value. The method 700, at step 708, further include calculating change to be made in each probabilistic parameter.

The method 700, at step 710 may include adapting probabilistic parameter based on the summary statistics obtained in the step 706, allowing for informed adjustments to GA's behavior. The probabilistic parameters are adjusted based on contribution of hyper-parameters in previous iterations to improve convergence and solution quality, leveraging past performance to inform future parameter adjustments. Further, the method 700, at step 712 may include feeding updated GA hyper-parameters.

As will be appreciated by those skilled in the art, the techniques described in the various embodiments discussed above are not routine, or conventional, or well understood in the art. The techniques discussed above provide for innovative solutions to address the challenges associated with updating the prediction model for the curing process design. The disclosed techniques offer several advantages over the existing methods:

Genetic Algorithm (GA): Genetic Algorithms (GA) offer significant advantages in scheduling problems by efficiently exploring large solution spaces and providing high-quality solutions. They adapt to complex, dynamic environments and handle multiple objectives. GA's stochastic nature avoids local optima, enhancing solution diversity. Additionally, their flexible representation makes them suitable for various scheduling scenarios, improving overall performance and robustness in finding optimal or near-optimal schedules.

Monte Carlo Tree Search (MCTS): it efficiently explores large decision spaces through random sampling and simulation, balancing exploration, and exploitation. MCTS adapts dynamically to changing conditions, handles uncertainty well, and improves over time with more simulations. Its flexibility allows integration with various heuristics and constraints, making it suitable for complex, real-world scheduling challenges.

Multi-Level Hierarchical Grouping (MLHG): It improves efficiency by organizing data into manageable clusters, reducing redundancy and computational complexity. This method enhances accuracy by systematically eliminating duplicates, ensuring unique solutions. Additionally, MLHG accelerates the search process, optimizes resource allocation, and increases the overall robustness and scalability of scheduling algorithms, making them more effective in handling large datasets.

Hierarchical groups: Hierarchical groups for parent and child populations in scheduling problems enhance solution quality and convergence speed. Parents contribute robust solutions, while children introduce diversity, preventing premature convergence. This structure allows effective exploration and exploitation of the solution space, leading to optimal schedules. Additionally, it facilitates parallel processing and scalable computations, making it efficient for complex, large-scale scheduling scenarios, ultimately improving overall computational performance and accuracy.

Probabilistic parameters: Probabilistic parameters in a scheduling problem offer several advantages, enhancing decision-making under uncertainty. These parameters enable the modeling of variability in task durations and resource availability, leading to more robust and adaptable schedules. This approach allows for better risk management by anticipating potential delays and disruptions, optimizing resource allocation, and improving overall efficiency and reliability in dynamic and unpredictable environments. Consequently, it increases the likelihood of meeting deadlines and achieving project goals.

Custom multi-objective sorting technique: A custom multi-objective sorting technique in scheduling problems offers enhanced flexibility and efficiency. It optimally balances multiple conflicting objectives, such as minimizing completion time and maximizing resource utilization. This tailored approach ensures more accurate priority handling, leading to better overall performance. Additionally, it can adapt to specific problem constraints and preferences, resulting in improved solution quality and decision-making precision in complex scheduling scenarios.

Summary statistics: Summary statistics offer significant advantages in scheduling problems by providing a clear, concise overview of key data points. They simplify complex data, highlight trends, and identify outliers, enabling more informed decision-making. This reduces the time and effort required to analyse data, improves the accuracy of schedules, and enhances resource allocation. Ultimately, summary statistics streamline the scheduling process, leading to increased efficiency and productivity. The summary statistics provides insight into performance of different subsets of solutions, and guides adjustments for the probabilistic parameters.

Mean objective value: The mean objective value provides a clear and concise measure of the average performance of a scheduling solution, making it easy to compare different schedules based on their overall effectiveness. It serves as a robust indicator for evaluating scheduling algorithms, enabling efficient optimization and decision-making processes. By focusing on the average outcome, it helps in identifying solutions that strike a balance between various conflicting objectives, ensuring practical and feasible scheduling solutions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A computer-implemented method for optimizing performance of a Genetic Algorithm (GA) in solving a scheduling problem, the computer-implemented method comprising:
receiving inputs constraints associated with supply and demand sides, for the scheduling problem;
initializing a set of schedules using an initializer that sets an initial set of solutions for the GA to start the optimization;
generating a parent population for the GA, wherein the parent population comprises a collection of potential solutions to the scheduling problem;
creating a child population via evolution using current probabilistic parameters comprising crossover and mutation operators, wherein new candidate solutions are produced by combining or modifying solutions of the collection of potential solutions from the parent population;
utilizing a Multi-Level Hierarchical Grouping (MLHG) to de-duplicate the child population, wherein the new candidate solutions are organized into hierarchical groups, and duplicates from the new candidates are removed;
determining a new population from a total population comprising the parent population and the child population, using a custom multi-objective sorting technique, wherein the new population comprises top-performing solutions;
updating probabilistic parameters of the GA during runtime using a runtime adapter, when pre-determined iterations unattained, wherein the probabilistic parameters are updated iteratively until an optimized schedule is attained.

2. The computer-implemented method of claim 1, further comprising determining if the pre-determined iterations are attained to determine whether the optimization has achieved pre-defined results or further iterations are required, wherein the determination is one of a successful determination or an unsuccessful determination.

3. The computer-implemented method of claim 2, further comprising:
at least one of:
upon the successful determination, rendering final schedules with optimal statistics and trade-offs as output; and
upon the unsuccessful determination, updating the probabilistic parameters of the GA during runtime using the runtime adapter.

4. The computer-implemented method of claim 1, wherein the initializer is a Monte Carlo Tree Search (MCTS) initializer.

5. The computer-implemented method of claim 1, wherein the custom multi-objective sorting technique is used to:
combine the parent population and the child population;
sort the combination based on multiple optimization objectives; and
select the top-performing solutions for a next generation.

6. The computer-implemented method of claim 1, further comprising classifying the new population into groups based on whether a crossover or a mutation is performed, facilitating dynamic adaptation of GA parameters to different operators.

7. The computer-implemented method of claim 6, wherein summary statistics are computed for each group of the groups, and wherein computation of the summary statistics provides insight into performance of different subsets of solutions, and guides adjustments for the probabilistic parameters.

8. The computer-implemented method of claim 7, wherein the summary statistics comprises a mean objective value.

9. The computer-implemented method of claim 7, wherein adjustments to be made in each probabilistic parameter are calculated based on the summary statistics obtained in a previous step, allowing for informed adjustments to GA's behavior.

10. The computer-implemented method of claim 1, wherein the probabilistic parameters are adjusted based on contribution of hyper-parameters in previous iterations to improve convergence and solution quality, leveraging past performance to inform future parameter adjustments.

11. A computer-implemented system for optimizing performance of a Genetic Algorithm (GA) in solving a scheduling problem, the computer system comprising: one or more computer processors, one or more computer readable memories, one or more computer readable storage devices, and program instructions stored on the one or more computer readable storage devices for execution by the one or more computer processors via the one or more computer readable memories, the program instructions comprising:
receiving inputs constraints associated with supply and demand sides, for the scheduling problem;
initializing a set of schedules using an initializer that sets an initial set of solutions for the GA to start the optimization;
generating a parent population for the GA, wherein the parent population comprises a collection of potential solutions to the scheduling problem;
creating a child population via evolution using current probabilistic parameters comprising crossover and mutation operators, wherein new candidate solutions are produced by combining or modifying solutions of the collection of potential solutions from the parent population;
utilizing a Multi-Level Hierarchical Grouping (MLHG) to de-duplicate the child population, wherein the new candidate solutions are organized into hierarchical groups, and duplicates from the new candidates are removed;
determining a new population from a total population comprising the parent population and the child population, using a custom multi-objective sorting technique, wherein the new population comprises top-performing solutions;
updating probabilistic parameters of the GA during runtime using a runtime adapter, when pre-determined iterations unattained, wherein the probabilistic parameters are updated iteratively until an optimized schedule is attained.

12. The computer-implemented system of claim 11, further comprising determining if the pre-determined iterations are attained to determine whether the optimization has achieved pre-defined results or further iterations are required, wherein the determination is one of a successful determination or an unsuccessful determination.

13. The computer-implemented system of claim 12, further comprising:
at least one of:
upon the successful determination, rendering final schedules with optimal statistics and trade-offs as output; and
upon the unsuccessful determination, updating the probabilistic parameters of the GA during runtime using the runtime adapter.

14. The computer-implemented system of claim 11, wherein the initializer is a Monte Carlo Tree Search (MCTS) initializer.

15. The computer-implemented system of claim 11, wherein the custom multi-objective sorting technique is used to:
combine the parent population and the child population;
sort the combination based on multiple optimization objectives; and
select the top-performing solutions for a next generation.

16. The computer-implemented system of claim 11, further comprising classifying the new population into groups based on whether a crossover or a mutation is performed, facilitating dynamic adaptation of GA parameters to different operators.

17. The computer-implemented system of claim 16, wherein summary statistics are computed for each group of the groups, and wherein computation of the summary statistics provides insight into performance of different subsets of solutions, and guides adjustments for the probabilistic parameters.

18. The computer-implemented system of claim 17, wherein adjustments to be made in each probabilistic parameter are calculated based on the summary statistics obtained in a previous step, allowing for informed adjustments to GA's behavior.

19. The computer-implemented system of claim 11, wherein the probabilistic parameters are adjusted based on contribution of hyper-parameters in previous iterations to improve convergence and solution quality, leveraging past performance to inform future parameter adjustments.

20. A non-transitory computer-readable storage medium having stored thereon computer executable instruction which when executed by one or more processors, cause the one or more processors to carry out operations for optimizing performance of a Genetic Algorithm (GA) in solving a scheduling problem, the operations comprising perform the operations comprising:
receiving inputs constraints associated with supply and demand sides, for the scheduling problem;
initializing a set of schedules using an initializer that sets an initial set of solutions for the GA to start the optimization;
generating a parent population for the GA, wherein the parent population comprises a collection of potential solutions to the scheduling problem;
creating a child population via evolution using current probabilistic parameters comprising crossover and mutation operators, wherein new candidate solutions are produced by combining or modifying solutions of the collection of potential solutions from the parent population;
utilizing a Multi-Level Hierarchical Grouping (MLHG) to de-duplicate the child population, wherein the new candidate solutions are organized into hierarchical groups, and duplicates from the new candidates are removed;
determining a new population from a total population comprising the parent population and the child population, using a custom multi-objective sorting technique, wherein the new population comprises top-performing solutions;
updating probabilistic parameters of the GA during runtime using a runtime adapter, when pre-determined iterations unattained, wherein the probabilistic parameters are updated iteratively until an optimized schedule is attained.
